(19) United States
(12) Patent Application Publication
(10) Pub. No.: US 2016/0010354 A1
(43) Pub. Date: Jan. 14, 2016

(54) Reinforcement Systems and Methods for Storage Covers

(71) Applicant: Donald J. GAUDET, JR., Ponchatoula, LA (US)

(72) Inventor: Donald J. Gaudet, III, Ponchatoula, LA (US)

(73) Assignee: J&M Industries, Inc., Ponchatoula, LA (US)

(21) Appl. No.: 14/769,978

(22) PCT Filed: Feb. 27, 2013
(86) PCT No.: PCT/US13/27856

§ 371 Date: Aug. 24, 2015

(51) Int. Cl. E04H 7/22; B32B 5/02; E04H 15/26; B32B 7/04; E04H 15/54; E04H 15/32; B32B 5/26; B32B 5/06

(52) U.S. Cl. CPC E04H 7/22; B32B 5/26; B32B 5/024; B32B 5/06; B32B 7/04; E04H 15/54; E04H 15/322; E04H 15/26; B32B 2262/0253; B32B 2262/0292; B32B 2471/00

(57) ABSTRACT

The present invention relates to reliable, efficient and low cost method and system for reinforcing fabric storage covers, particularly for fabric storage covers used in covering grain piles. The reinforced storage covers target the areas of the fabric storage covers that experience particular high stress and strain during deployment and filling.

### BACKGROUND OF THE INVENTION

I. Field of the Invention

The present invention relates to novel reinforcement systems for storage covers, and more particularly woven polyethylene or string reinforced polyethylene fabric storage covers.

II. General Background

Various types of fabric storage covers have been developed for covering piles or mounds of material, such as salt, sand, calcium carbonate, grain, and the like from the effects of weather, sun, air intrusion, water intrusion and/or insect or rodent infestations while said material is in outside storage. In one general type of fabric storage covers, these fabric storage covers consist of a fabric tarp wherein the perimeter of the fabric tarp is secured to a retaining wall extending around the perimeter of the fabric tarp. At the center of the fabric tarp, and connected to the fabric tarp, exists a lifting ring. After the fabric storage cover is deployed and attached to the lifting ring, the lifting ring is raised and the particulate material is deposited through the lifting ring and under the fabric storage cover.

Previously, fabric storage covers were created using a vinyl material. Using vinyl for the fabric tarp resulted in strong but expensive fabric storage covers, and as a result the fabric storage covers were intended to be reusable year to year and season to season. However, while being stored between uses, the vinyl fabric storage covers were susceptible to destruction by rodents and other causes of degradation of the storage covers. Thus, there existed a need for fabric storage covers that were relatively inexpensive to produce, and thus could be purchased annually or seasonally. This would eliminate the need to store the fabric storage covers between uses.

As a result of this need, fabric storage covers were created using woven polyethylene fabric or string reinforced polyethylene for the fabric tarp. The woven polyethylene and string reinforced polyethylene storage covers are relatively less expensive to produce. However, woven polyethylene and string reinforced polyethylene storage covers are often not as strong as the vinyl previously used for the storage covers. As a result, a fabric stronger than woven polyethylene or string reinforced polyethylene is often needed in the areas of the fabric storage cover that experience particularly high stress and strain. Such high stress and strain areas include the area around the lifting ring where the fabric storage cover attaches to the lifting ring. Specifically, there is increased stress and strain when the lifting ring is raised during the filling process. As a result, a yoke made of stronger material which is better capable to handle the stress and strain near the lifting ring, such as vinyl, is often used to surround the lifting ring, and the yoke is then attached to the woven polyethylene or string reinforced polyethylene fabric tarp that makes up the remainder of the fabric storage cover.

Current state of the art fabric storage covers connect a vinyl yoke to the woven polyethylene or string reinforced polyethylene fabric tarp by stitching the yoke to the fabric tarp. However, stitching results in small holes in the fabric storage cover which can allow moisture to permeate the storage cover.

Additionally, string reinforced polyethylene fabric and thin woven polyethylene fabric is prone to stretching. If stretched, the string reinforced polyethylene fabric and thin woven polyethylene fabric can tear or release from the stitching creating a tear or hole in the fabric storage cover. Thus, there is a need for a reinforced fabric storage cover wherein the yoke is attached to the fabric tarp with the least amount of stitching possible.

Heat welding is also a method of attaching fabrics together. However, certain types of fabrics and/or certain thicknesses of fabric cannot be attached together via heat welding as an adequate seal will not be formed. Thus, there is a need for a reinforced fabric storage cover wherein the components form an adequate seal to maintain the integrity of the fabric storage cover when heat welding is utilized.

The present invention provides a reliable, efficient and low cost method and system for reinforcing fabric storage covers, particularly in the areas of the fabric storage covers that experience high stress and strain.

### SUMMARY OF THE PRESENT INVENTION

An aspect of the present invention includes a fabric storage cover comprising a yoke, a transition panel wherein said transition panel is adjacent to and connected to said yoke, a tarp body wherein said tarp body is adjacent to and connected to said transition panel, and a reinforcing band wherein said reinforcing band is connected to said yoke and said tarp body.

A further aspect of the present invention includes a method of reinforcing a fabric storage cover which comprises the steps of providing a yoke, connecting a transition panel to said yoke, further connecting a tarp body to said transition panel, and securing a plurality of reinforcing bands to said yoke and to said tarp body.

A further aspect of the present invention includes a method of covering a pile of particulate material comprising the steps of providing a retainng wall surrounding an area of ground, deploying a reinforced fabric storage cover within said area of ground wherein said reinforced fabric storage cover comprises a center opening, a lifting ring circumscribing said center opening, a yoke connected to said lifting ring, a transition panel connected to said yoke, a tarp body connected to said transition panel wherein said tarp body comprises a perimeter, and a plurality of reinforcing bands secured to said yoke and to said tarp body, lifting said lifting ring, deposition said particulate material through said center opening and underneath said fabric storage cover, and securing said perimeter of said tarp body to said retaining wall.

Yet another aspect of the present invention is a fabric storage cover comprising means for lifting said fabric storage cover, a means for surrounding said lifting means wherein said surrounding means is attached to said lifting means, a means for covering a volume, and a means for transitioning wherein said transitioning means connects said surrounding means to said covering means.

Yet another aspect of the present invention is a covering system comprising a lifting ring, a reinforced fabric storage cover comprising a yoke wherein said yoke is attached to said lifting ring, a transition panel wherein said transition panel is connected to said yoke, a tarp body wherein said tarp body is connected to said transition panel wherein said tarp body comprises a perimeter, and a plurality of reinforcing bands wherein said plurality of reinforcing bands are secured to said yoke and to said tarp body, and a retaining wall wherein said perimeter of said tarp body is secured to said retaining wall.

### BRIEF DESCRIPTION OF THE DRAWINGS

For a further understanding of the nature and objects of the present invention, reference should be had to the following descriptions taken in conjunction with the accompanying drawings in which like parts are given like reference numerals.

FIG. 1 shows a side view of a particulate pile surrounded by the retaining wall and covered by the fabric storage cover.

FIG. 2 shows an initial step in joining a yoke, transition panel, tarp body and reinforcing bands.

FIG. 3 shows a subsequent step in joining a yoke, transition panel, tarp body and reinforcing bands.

FIG. 4 shows a planar view of the interior side of a fabric storage cover.

FIG. 5 shows a partial view of the interior side of a fabric storage cover.

FIG. 6 shows a partial view of the interior side of a fabric storage cover.

### DETAILED DESCRIPTION

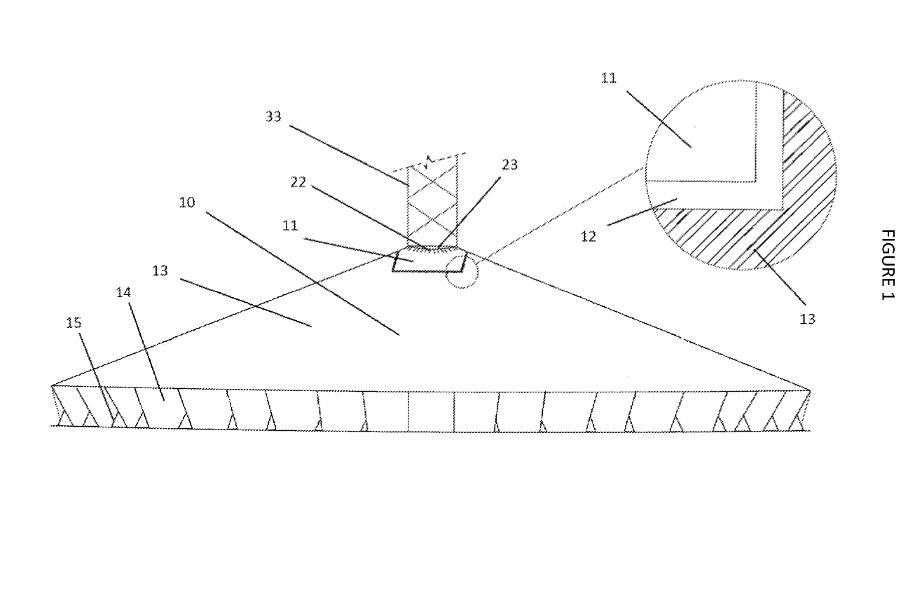

Fabric storage covers 10 can come in a variety of size and shapes, and often are designed to specific customer specifications. FIG. 1 shows a side view of a particulate pile surrounded by a retaining wall 14, secured by braces 15, and covered by a fabric storage cover 10 of the present invention. The fabric storage cover 10 comprises a yoke 11, a transition panel 12 and a tarp body 13. In this embodiment, the fabric storage cover 10 is circular in shape, but in alternative embodiments the fabric storage cover 10 may be oval or of a different shape. In the embodiment shown in FIG. 1 at the center of the fabric storage cover 10 is a center opening 23. In alternate embodiments the center opening 23 may be located in alternate locations or comprise multiple center openings 23. For example, a fabric storage cover 10 that is oval in shape may comprise two center openings 23 at opposite ends of the longitudinal axis of the oval shaped fabric storage cover 10.

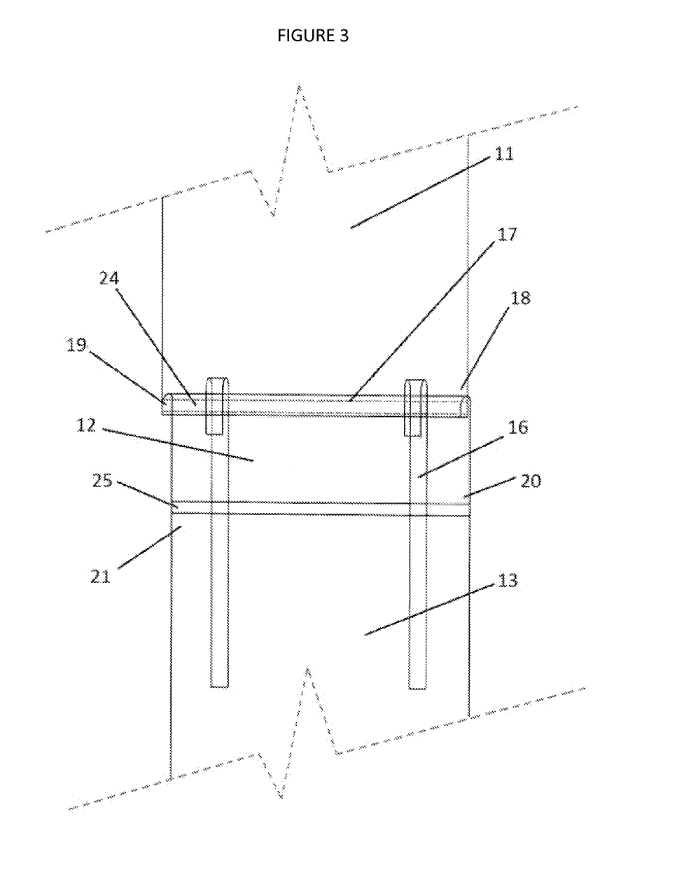

In order to deposit particulate material under the fabric storage cover 10, a lifting ring 22, which circumscribes the center opening 23, must be attached to the fabric storage cover 10 so that the lifting ring 22 may be used to lift the fabric storage cover 10 off of the ground thereby allowing particulate material to be deposited through the center opening 23 and underneath the fabric storage cover 10. The particulate material is often deposited via a center tower 33 that attaches to the lifting ring 22. In the present invention the yoke 11 encloses the lifting ring and surrounds the center opening 13. The method of attaching the yoke 11 to a lifting ring is known in the art. In one embodiment, the yoke 11 has a square perimeter. However, the yoke 11 may alternatively comprise a circular, oval or other shaped perimeter. Attached to and surrounding the yoke 11 is the transition panel 12. The transition panel 12 of FIG. 1 has a square perimeter; however, alternatively, the transition panel 13 may comprise a circular, oval or other shaped perimeter. Attached to and surrounding the transition panel is the tarp body 13 which makes up the remainder of the fabric storage cover 10 wherein the outer perimeter of the tarp body 13 is secured to the retaining walls 14. The yoke 11, transition panel 12 and the tarp body 13 are used in connection with reinforcing bands 16 (FIG. 3) to form an enhanced reinforcement system for the fabric storage cover 10.

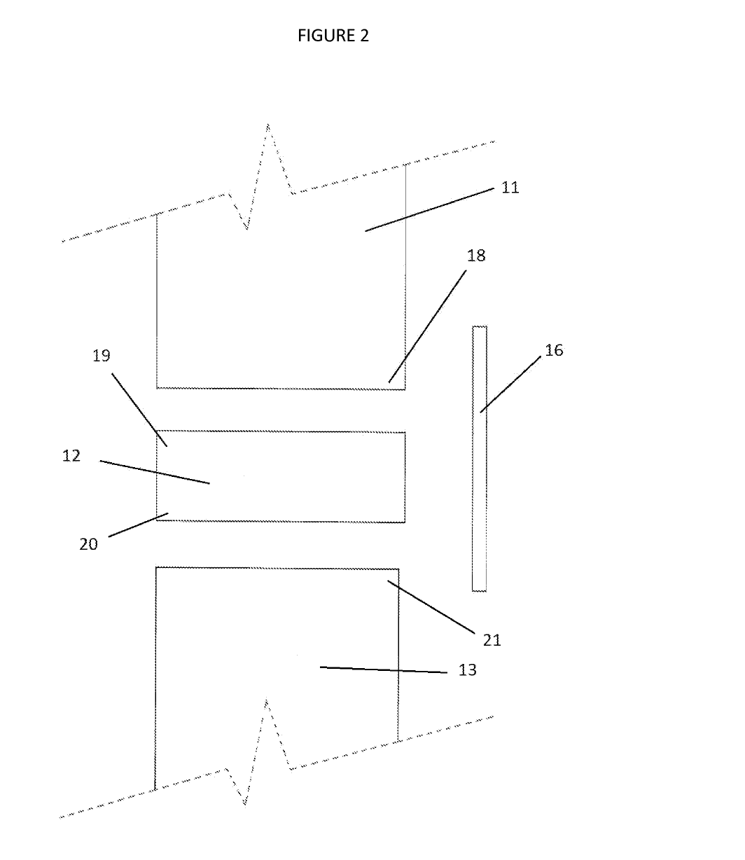

FIGS. 2 and 3 show how the yoke 11, transition panel 12, tarp body 13 and reinforcing bands 16 form the enhanced reinforcement system. FIG. 2 shows the yoke 11, transition panel 12, tarp body 13 and reinforcing bands 16 (showing one of multiple reinforcing bands 16) separately prior to securing them together. The yoke 11 may be made of one of, or a combination of, a variety of materials, including, but not limited to 22 to 30 oz. vinyl coated fabric (also known as polyvinyl chloride or PVC fabric), 20 to 30 oz. neoprene or urethane fabric or 12 oz. woven polyethylene fabric. The transition panel 12 may be made of one of, or a combination of, a variety of materials, including, but not limited to, 20-24 mil woven polyethylene fabric or 16 to 20 mil string reinforced polyethylene fabric (wherein a mil equals 1/1000 of an inch). The tarp body 13 is chosen based on customer preference and the intended use of the fabric storage cover 10, and may be made of one of, or a combination of, a variety of materials, including, but not limited to, 9 to 24 mil woven polyethylene fabric or 6 to 16 mil string reinforced polyethylene fabric. The reinforcing bands 16 may also be made of one of, or a combination of, a variety of materials, including, but not limited to, 30 mil linear low density polyethylene (LLDPE) with a 7×7 reinforcing scrim.

FIG. 3, viewed from the interior of the fabric storage cover 10 (wherein the interior refers to the side of the fabric storage cover facing the particulate being stored and, conversely, the exterior refers to the side of the fabric storage cover facing the outdoors), shows how the yoke 11, transition panel 12, tarp body 13 and reinforcing bands 16 are attached together. The following describes one embodiment of the present invention, however, the yoke 11, transition panel 12, tarp body 13 and reinforcing bands 16 may be arranged in various other arrangements. The yoke outer edge 18 is attached to the transition panel inner edge 19. Specifically, the transition panel inner edge 19 is folded over towards the exterior of the fabric storage cover 10 and sewed (using size 207 twisted polyester thread and a Juki brand sewing machine) to the yoke outer edge 18 using stitching 17 to create a stitched seam 24. Alternatively, the transition panel inner edge 19 may be folded over towards interior of the fabric storage cover 10. Folding over the transition panel inner edge 19 provides increased strength of the stitched seam 24 and aids in preventing moisture from permeating the fabric storage cover 10.

Additionally, every 4 to 6 feet, with every 6 feet being suitable for many applications, reinforcing bands 16 are stitched to the yoke outer edge 18 and the transition panel inner edge 19. When sewing the reinforcing bands 16, the top edge of the reinforcing bands 16 is folded over approximately 4 inches, as shown in FIG. 3, so that the stitching 17 passes through two layers of each reinforcing band 16. This fold over of the reinforcing bands 16 better secures the reinforcing bands 16 to the yoke 11 and the transition panel 13.

When the sewing of the of the yoke 11 to the transition panel 12 and the reinforcing bands 16 is complete and when viewing the stitched seam 24, the yoke 11 is the exterior most layer of fabric, with the transition panel 12 interior to the yoke 11 and the reinforcing bands 17 interior to the transition panel 12.

Further, the transition panel outer edge 20 is overlapped with the tarp body inner edge 21 (so that the tarp body inner edge 21 is interior to the transition panel outer edge 20) and heat welded together using a Miller Weldmaster TG3600 or Leister Variant T1 welding machine, or any similar heat welding machine known in the art, to form a heat weld seam 25 of approximately 2 inches in width. Alternatively, the tarp body inner edge 21 may be exterior to the transition panel outer edge 20. The heat weld seam 25 could also be welded with an extrusion welding machine. Because the transition panel 12 is generally of a weight or thickness greater than the tarp body 13 but less than the yoke 11, the transition panel 12 allows the connection of the two different materials, such as the vinyl of a yoke 11 and the woven polyethylene or string reinforced polyethylene of a tarp body 13, that normally could not be directly head welded together. The use of heat welding to create the heat weld seam 25 also reduces the sewing required which aids in preventing moisture from permeating the fabric storage cover 10.

Additionally, the length of the reinforcing bands 16 are heat welded (using a Leister Variant T1 welding machine) to the tarp body 13. The heat welding of the reinforcing bands 16 to the tarp body 13 strengthens and reinforces the connection between the yoke 11 and the tarp body 13, and prevents rips and tears in the fabric storage cover 10 that would otherwise occur due to a high amount of stress and strain placed on the fabric storage cover 10, especially near the lifting ring 22. The reinforcing bands 16 could also be heat welded to the tarp body 13 using an extrustion welding machine. As an optional step, tape may be applied to seams and/or other locations (such as the exterior side of the tarp body 13) to further water-proof the fabric storage cover 10.

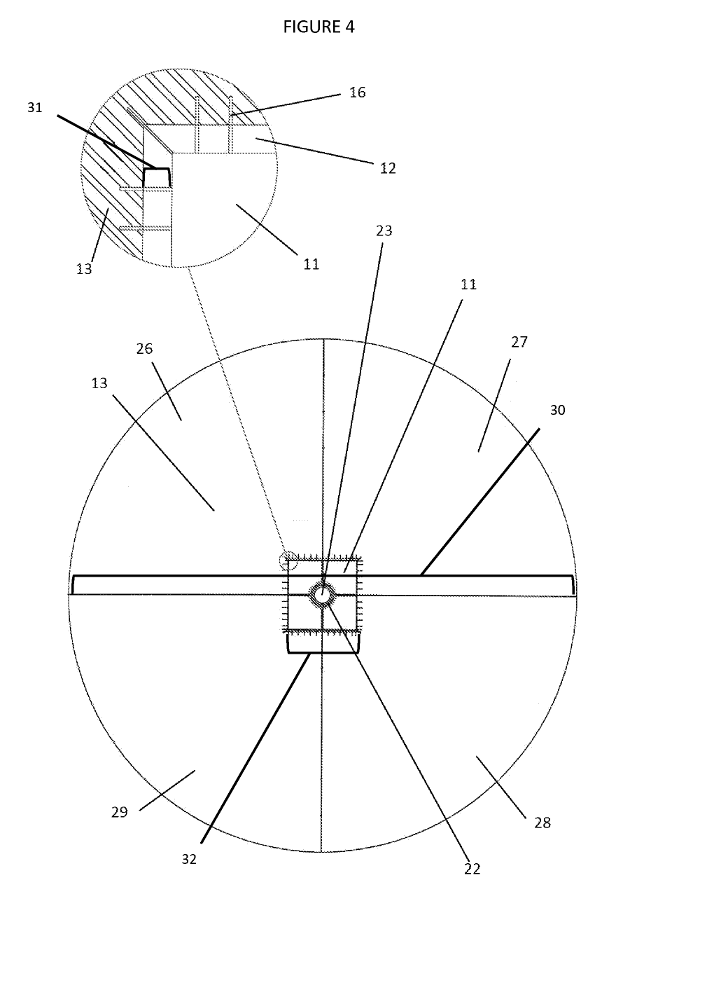

FIG. 4 shows a plan view of the interior of one embodiment of a fabric storage cover 10 of the present invention, and further depicts a lifting ring 22 attached to the yoke 11, by bolting or other similar means known in the art. The complete fabric storage cover 10 may be assembled from multiple sections. In the embodiment shown in FIG. 4, the fabric storage cover 10 is assembled from four sections, a first section 26, a second section 27, a third section 28 and a fourth section 29. In this configuration, the edges of each section 26, 27, 28 and 29, are secured to the adjacent sections using opposing grommets and plastic tie wraps, cords, cable, chains, carabineers or other closing mechanisms known in the art.

The diameter of the tarp body 30 varies depending on customer specifications and its intended use, but generally ranges from 90-500 feet. The width of the transition panel 31 also varies depending on the size of the tarp body, but generally is approximately 12 inches in width. The width of the yoke 32 varies depending on the size of the tarp body 13 and the lifting ring 22, but generally is approximately 48 feet in width, but can also range from 12 feet to 60 feet in width. The reinforcing bands 16 are generally 2 inches in width and four feet in length. The reinforcing bands 16 can be longer if additional reinforcement is required or shortened if less reinforcement is required.

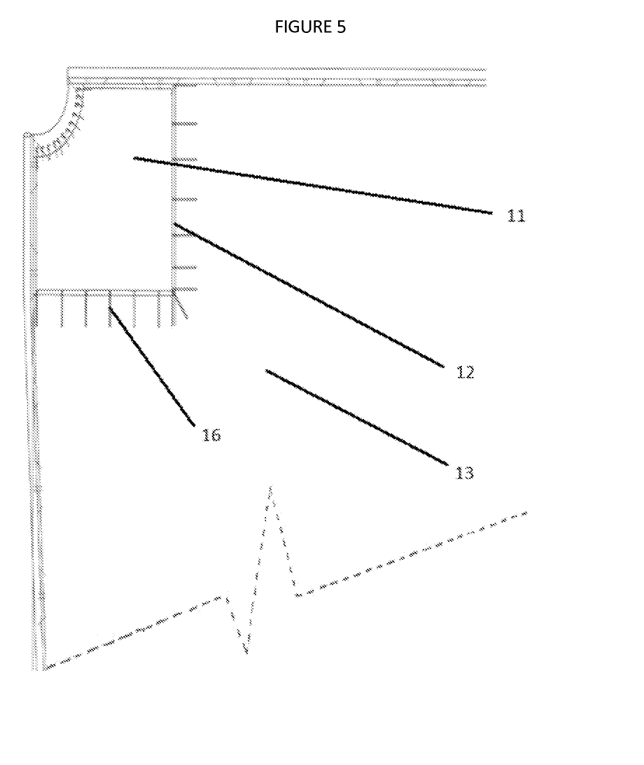

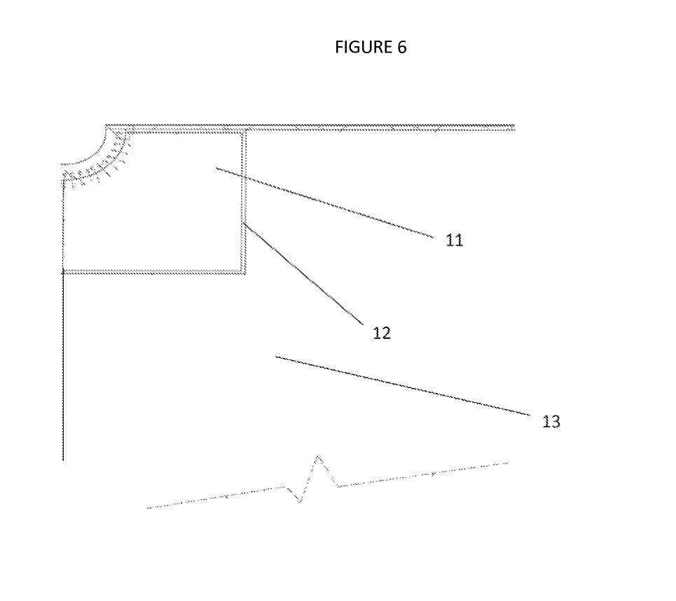

FIG. 5 shows a close-up view of the interior of one section of a fabric storage cover 10 of one embodiment of the present invention, and FIG. 6 shows a close-up view of the exterior of one section of a fabric storage cover 10 of one embodiment of the present invention. As can be seen in the figures, the reinforcing bands 16 can only been seen from the interior of the fabric storage cover 10.

1. A fabric storage cover comprising:
a yoke;
a transition panel wherein said transition panel is adjacent to and connected to said yoke;
a tarp body wherein said tarp body is adjacent to and connected to said transition panel; and
a reinforcing band wherein said reinforcing band is connected to said yoke and said tarp body.

2. The fabric storage cover of claim 1, wherein said yoke comprises an inner edge and an outer edge and said transition panel comprises an inner edge and an outer edge;
wherein said yoke outer edge and said transition panel inner edge are connected using stitching to form a stitched seam.

3. The fabric storage cover of claim 2, wherein said yoke further comprises an interior side and an exterior side and said transition panel further comprises an interior side and an exterior side; wherein said exterior side of said transitional panel inner edge is connected to said interior side of said yoke outer edge using stitching to form a stitched seam.

4. The fabric storage cover of claim 2, wherein said reinforcing band comprises an upper edge, a lower edge and a length; and
wherein said reinforcing band upper edge is connected to said stitched seam.

5. The fabric storage cover of claim 4, wherein said reinforcing band upper edge is folded over at a distance from said reinforcing band upper edge; and said folded over reinforcing band is connected to said stitched seam.

6. The fabric storage cover of claim 5, wherein said distance is about 4 inches.

7. The fabric storage cover of claim 4, wherein said tarp body comprises an inner edge and an outer edge, and
wherein said transition panel outer edge and said tarp body inner edge are connected using heat welding to form a heat weld seam.

8. The fabric storage cover of claim 7, wherein said reinforcing band is heat welded to said tarp body.

9. The fabric storage cover of claim 8, wherein said tarp body comprises an interior side and an exterior side, and
wherein said reinforcing band is heat welded to said tarp body interior side.

10. The fabric storage cover of claim 8 comprising a plurality of said reinforcing bands.

11. The fabric storage cover of claim 10 comprising a plurality of said reinforcing bands, and wherein each of said plurality of said reinforcing bands is located at four to six feet intervals along said stitched seam.

12. The fabric storage cover of claim 11 wherein said yoke is comprised of vinyl fabric.

13. The fabric storage cover of claim 12 wherein said reinforcing bands are comprised of linear low density polyethylene fabric with a reinforcing scrim.

14. The fabric storage cover of claim 13 wherein said transition panel is comprised of woven polyethylene fabric.

15. The fabric storage cover of claim 14 wherein said tarp body is comprised of woven polyethylene fabric.

16. The fabric storage cover of claim 15 wherein said woven polyethylene fabric comprising said transition panel has a first thickness and said woven polyethylene fabric comprising said tarp body has a second thickness; wherein said first thickness is greater than said second thickness.

17. The fabric storage cover of claim 14 wherein said tarp body is comprised of string reinforced polyethylene fabric.

18. The fabric storage cover of claim 13 wherein said transition panel is comprised of string reinforced polyethylene fabric.

19. The fabric storage cover of claim 18 wherein said tarp body is comprised of string reinforced polyethylene fabric.

20. The fabric storage cover of claim 19 wherein said string reinforced polyethylene fabric comprising said transition panel has a first thickness and said string reinforced polyethylene fabric comprising said tarp body has a second thickness; wherein said first thickness is greater than said second thickness.

21. The fabric storage cover of claim 18 wherein said tarp body is comprised of woven polyethylene fabric.

22. The fabric storage cover of claim 1 wherein said yoke is comprised of a fabric selected from a group consisting of: vinyl fabric, neoprene fabric, urethane fabric and woven polyethylene fabric having a weight of 12 ounces or greater.

23. The fabric storage cover of claim 22 wherein said transition panel is comprised of a fabric selected from a group consisting of: woven polyethylene fabric of 20 to 24 mils in thickness and string reinforced polyethylene fabric of 16 to 20 mils in thickness.

24. The fabric storage cover of claim 23 wherein said tarp body is comprised of a fabric selected from a group consisting of: woven polyethylene fabric of 9 to 24 mils in thickness and string reinforced polyethylene fabric of 6 to 16 mils in thickness.

25. The fabric storage cover of claim 24 wherein said reinforcing band is approximately four feet in length.

26. The fabric storage cover of claim 1 wherein said transition panel has a first thickness and said tarp body has a second thickness; wherein said first thickness is greater than said second thickness.

27. A method of reinforcing a fabric storage cover which comprises the steps of:
a. providing a yoke;
b. connecting a transition panel to said yoke;
c. further connecting a tarp body to said transition panel; and
d. securing a plurality of reinforcing bands to said yoke and to said tarp body.

28. The method of claim 27 wherein said yoke is connected to said transition panel using stitching to create a stitched seam.

29. The method of claim 28 wherein said tarp body is connected to said transition panel using heat welding to create a heat weld seam.

30. The method of claim 29 wherein a respective reinforcing band of said plurality of reinforcing bands is secured to said yoke at said stitched seam using stitching and secured to said tarp body using heat welding.

31. The method of claim 30 wherein said each of said plurality of reinforcing bands is located every four to six feet along said stitched seam.

32. A method of covering a pile of particulate material comprising the steps of:
a. providing a retaining wall surrounding an area of ground;
b. deploying a reinforced fabric storage cover within said area of ground wherein said reinforced fabric storage cover comprises a center opening, a lifting ring circumscribing said center opening, a yoke connected to said lifting ring, a transition panel connected to said yoke, a tarp body connected to said transition panel wherein said tarp body comprises a perimeter, and a plurality of reinforcing bands secured to said yoke and to said tarp body;
c. lifting said lifting ring;
d. depositing said particulate material through said center opening and underneath said fabric storage cover; and
e. securing said perimeter of said tarp body to said retaining wall.

33. A fabric storage cover comprising:
a. a means for lifting said fabric storage cover;
b. a means for surrounding said lifting means wherein said surrounding means is attached to said lifting means;
c. a means for covering a volume; and a
d. means for transitioning wherein said transitioning means connects said surrounding means to said covering means.

34. The fabric storage cover of claim 33 further comprising a means for securing said covering means to said surrounding means.

35. A covering system comprising:
a. a lifting ring;
b. a reinforced fabric storage cover comprising a yoke wherein said yoke is attached to said lifting ring, a transition panel wherein said transition panel is connected to said yoke, a tarp body wherein said tarp body is connected to said transition panel wherein said tarp body comprises a perimeter, and a plurality of reinforcing bands wherein said plurality of reinforcing bands are secured to said yoke and to said tarp body; and
c. a retaining wall wherein said perimeter of said tarp body is secured to said retaining wall.
